(19) United States
(12) Patent Application Publication
(10) Pub. No.: US 2025/0347422 A1
(43) Pub. Date: Nov. 13, 2025

(54) HOUSEHOLD APPLIANCE HAVING A MOVABLE CLOSURE ELEMENT

(71) Applicant: Miele & Cie. KG, Gütersloh (DE)

(72) Inventor: Dennis WITHOT, Warendorf (DE)

(21) Appl. No.: 19/200,736

(22) Filed: May 7, 2025

(30) Foreign Application Priority Data
May 13, 2024 (DE) 10 2024 113 208.6

(51) Int. Cl. F24C 15/02; E05F 15/616

(52) U.S. Cl. CPC F24C 15/023; E05F 15/616

(57) ABSTRACT

A household appliance includes: an interior space for receiving at least one object to be treated through an access opening along a longitudinal axis; a closure element for closing and clearing the access opening to the interior space from a front of the household appliance by being pivoted up and down about a pivot; a closing mechanism for exerting a closing torque on the closure element when the closure element is in a pivoted-up position and closes the access opening; a kinematic linkage for transmitting a driving force of a drive unit to the closure element and thereby pivot the closure element up and down, and overcoming the closing torque of the closing mechanism while the closure element is being pivoted down; and an elongated pivot element receptacle of the closure element, the elongated pivot element receptacle receiving a pivot element of the kinematic linkage rotationally and translationally movably therein.

### CROSS-REFERENCE TO PRIOR APPLICATION

Priority is claimed to German Patent Application No. DE 10 2024 113 208.6, filed on May 13, 2024, the entire disclosure of which is hereby incorporated by reference herein.

### FIELD

The invention relates to a household appliance having a movable closure element.

### BACKGROUND

There are known cooking appliances which have a cooking chamber that is configured in immovable (i.e., stationary) relationship with the cooking appliance and in which the item to be cooked can be disposed in or on a cookware item and cooked while the cooking chamber of the cooking appliance is closed. A cooking appliance of this type can be, for example, an oven, a steam cooker, a combination appliance composed of an oven with a steam cooker, and the like. At least in Germany, such cooking appliances with a stationary cooking chamber typically have an overall height (along the vertical axis) of about 45 cm, but ovens with an overall height of about 60 cm are also common.

Such cooking appliances with a stationary cooking chamber have in common that they have an outer housing as an outer enclosure that substantially encloses the cooking appliance outwardly, protecting the individual components and elements thereof and allowing them to be handled together. Formed within the cooking appliance is an interior space which constitutes the cooking chamber and is substantially enclosed by an inner housing as an inner enclosure, also referred to as the cooking chamber shell or oven shell. Between the inner enclosure and the outer enclosure, a housing space is formed as an interstitial space in which may be disposed functional elements of the cooking appliance, such as a controller or control unit, an electrical power supply, and other components that serve the intended use of the cooking appliance. As viewed along the depth from the front, i.e. from the perspective of a user, the outer enclosure or a front panel in the form of a furniture material or in the form of a control panel and the like, together with the inner enclosure, encloses the housing space so that the housing space is not accessible to the user.

As viewed along the depth, the interior space of the cooking appliance has a front-facing through-opening as an access opening through which the interior space of the cooking appliance is accessible to the user, allowing the user to insert and position cookware items in the interior space of the cooking appliance as its cooking chamber and to take out and remove cookware items from the interior space of the cooking appliance after the treatment of the item to be cooked is complete. The user can open the access opening by means of a closure element, for example, in the form of a side-swinging door, a drop-down door, and the like, in order to access the interior space of the cooking appliance as previously described, or to close the interior space of the cooking appliance and perform the cooking operation or process. Such a closure element may be of a closed design or may have a viewing window to allow the user to look into the closed interior space of the cooking appliance.

Such cooking appliances with a stationary cooking chamber are typically designed as built-in appliances or built-in kitchen appliances to be fixedly disposed in a space-saving manner with their outer enclosure in kitchen furniture, such as built-in kitchen cabinets, at a height (along the vertical axis) that is easily accessible to the user and such that their closure element and, if present, also their front panel (see above) is/are flush with the surfaces of the other cooking appliances, drawers, doors, and the like, of the kitchen furniture, as viewed looking toward the user, which can improve the visual appearance to the user. However, such cooking appliances may also be designed as individual, separate appliances that can be placed and operated in particular on a countertop of a run of kitchen units. This can simplify flexibility of use as well as the acquisition and disposal.

In such cooking appliances, the closure element, such as a door mounted to swing sideways or a drop-down door that can be swung up from below, is operated manually by a human user, i.e., grasped by a handle, grip bar, or the like with the fingers of a hand, to be moved or swung back and forth between the fully open state for easiest possible access to the cooking chamber and the fully closed state to perform the cooking process. This can also be accomplished by a back-and-forth translational movement along the longitudinal axis if the closure element can be pulled out and pushed in. Mixed rotational/translational pivoting movements are also possible using suitable kinematic mechanisms. In any case, intermediate positions are also possible to open the cooking chamber only slightly, for example, for venting or cooling after a cooking process.

In order to relieve the user from performing these movements between the fully open state and the fully closed state, it is also known to use a drive, in particular an electric drive, for this purpose. The previously described pivoting movements are effected by means of an, in particular electric, rotationally drivable motor capable of converting its rotational motion via a crank into a translational motion along the longitudinal axis, which, similar to the motion of the hand of the user, can then pivot the closure element back and fourth (i.e., open and closed) about its axis of rotation.

In the case of ovens, steam cookers, and oven/steam cooker combination appliances, for example, it is common for the closing element to be configured as a drop-down door that can be swung up and down the user or a motor by means of a pivoting movement about a pivot axis extending along the transverse axis. Zero degrees of the pivoting movement corresponds to the fully closed access opening, in which the closure element in the form of a drop-down door points directly upward in the vertical direction. 90 degrees of the pivoting movement corresponds to the fully open access opening, in which the closure element or drop-down door is oriented horizontally.

It is known that with such swinging closure elements or drop-down doors, such oven doors, an additional mechanism, such as a mechanical spring element, is usually provided to press the closure element securely against a seal of the access opening in the raised state, i.e., in the position closing the access opening, and to thereby reliably close the access opening in a gas-and liquid-tight manner. This closing mechanism thus applies a closing torque to the closure element or to the drop-down door, the closing torque adding to the torque that has be overcome by the drive of the automatic or self-acting movement mechanism in order to move the closure element. Therefore, the drive must be of sufficient power to overcome the closing torque of the closing mechanism in order to open the closure element.

However, since this closing mechanism operates only when the closure element is fully closed, and thus the respective, relatively high closing torque acts only in this position of the closure element, the correspondingly powerful drives or their motors have heretofore been significantly oversized in terms of the remaining movement of the closure element for opening the access opening.

Cooking appliances of the aforementioned type are known from patent publications EP 2 759 669 A2 and EP 1 548 366 A2 and DE 20 2020 104 182 U1 and CN 110 761 648 A1.

### SUMMARY

In an embodiment, the present invention provides a household appliance, comprising: an interior space configured to receive at least one object to be treated through an access opening along a longitudinal axis; a closure element configured for closing and clearing the access opening to the interior space from a front of the household appliance by being pivoted up and down about a pivot; a closing mechanism configured to exert a closing torque on the closure element when the closure element is in a pivoted-up position and closes the access opening; a kinematic linkage configured to transmit a driving force of a drive unit to the closure element and thereby pivot the closure element up and down, and to overcome the closing torque of the closing mechanism while the closure element is being pivoted down; an elongated pivot element receptacle of the closure element, the elongated pivot element receptacle being configured to receive a pivot element of the kinematic linkage rotationally and translationally movably therein; a transmission element pivotally mounted on the closure element; and a spring element configured to push the transmission element of the closure element away from the access opening against the pivot element of the kinematic linkage and thereby translationally move the pivot element of the kinematic linkage.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective oblique front view from above showing an inventive household appliance in the form of a cooking appliance with the access opening open;

FIG. 2 is a side view of a kinematic linkage of the inventive cooking appliance, partly in longitudinal section;

FIG. 3 is a side view of a first design variant of the closure element of the household appliance, showing it in a position closing the access opening;

FIG. 4 is a detail view of the lower portion of the closure element of FIG. 3;

FIG. 5 is a side view of a first design variant of the closure element of the household appliance, showing it at the beginning of an opening movement out of the position closing the access opening; and

FIG. 6 is a detail view of the lower portion of the closure element of FIG. 5;

FIG. 7 is a side view of a second embodiment of a closure element of the household appliance, showing it in a position closing the access opening; and

FIG. 8 is a detail view of the transmission element of the portion of the transmission element of FIG. 7.

### DETAILED DESCRIPTION

In an embodiment, the present invention provides a household appliance, preferably a cooking appliance, having a closure element that is movable, in particular in a motor-driven manner, such that during the automatic opening of closure element, a relatively high torque can be applied using a relatively low-powered drive. In particular, a closing torque of the closed closure element can be overcome by a relatively low-powered drive. In particular, it can be possible to use a drive that is suitably dimensioned for the entire movement for the automatic opening of the closure element. This can be achievable in a most simple, cost-effective, and/or space-saving manner. An alternative to the known household appliances of this type can be provided.

Thus, the invention relates to a household appliance, preferably a cooking appliance, having an interior space configured to receive at least one object to be treated through an access opening along the longitudinal axis, and having a closure element configured for closing and clearing the access opening to the interior space from the front by being pivoted up and down about a pivot, and further having a closing mechanism configured to exert a closing torque on the closure element when the closure element is in the pivoted-up position and closes the access opening, and further having a kinematic linkage configured to transmit a driving force of a drive unit to the closure element and thereby pivot the closure element up and down and to overcome the closing torque of the closing mechanism while the closure element is being pivoted down.

The household appliance may in particular be a cooking appliance, but may also be another household appliance such as a washing machine, a dryer, or the like. In this case, the object to be treated may be laundry to be washed or dried. When embodied as a cooking appliance, the household appliance may be an oven, an oven with an integrated microwave, a pure microwave oven, a Dialog cooker, a steam oven, a steam cooker, and the like. In this case, the object to be treated may be an item to be cooked, i.e., a food item to be cooked.

The household appliance is characterized by an elongated pivot element receptacle of the closure element, which receives a pivot element of the kinematic linkage rotationally and translationally movably therein, a transmission element pivotally mounted on the closure element, and a spring element configured to push the transmission element of the closure element away from the access opening against the pivot element of the kinematic linkage and thereby translationally move the pivot element of the kinematic linkage.

One aspect is that the pivot, the pivot element receptacle, the transmission element, and the spring element are configured
such that the pivot element of the kinematic linkage moves along the elongated pivot element receptacle of the closure element toward the transmission element and pivots the transmission element against the spring element, thereby creating a greater lever arm between the spring element and the pivot of the closure element when the pivot element of the kinematic linkage is moved by the drive unit to the position closing the access opening, and
such that the pivot element of the kinematic linkage moves along the elongated pivot element receptacle of the closure element away from the transmission element, and the spring element pivots the transmission element, thereby creating a smaller lever arm between the spring element and the pivot of the closure element when the pivot element of the kinematic linkage is moved by the drive unit out of the position closing the access opening.

In other words, in previous automatic or self-acting movement mechanisms of this type, a spring force acts through a roller on an inclined plane. Multiplication of the component force by the resulting lever arm yields the closing torque for a hinge. During forward movements produced by the drive, i.e., movements toward the user, the connecting element or connecting bar that drives a pivot element in the form of a rivet causes the closure element or its frame or blade to rotate about the pivot, so that an opening and closing process can take place.

Further advantages of the invention include simplification of the selection of the spring for the hinge and elimination of movement noises, in particular during manual operation, as well as reduction of the opening forces, especially during motor operation, and improvement of the manufacturability of the cam, as well as elimination of a point of halt in the closing movement, in particular at the angle of about 45 degrees, the first contact of the roller and the cam.

According to the invention, the frame or the blade of the closure element is augmented with a rotatable element, i.e., the blade is configured of two parts, so that an additional component in the form of a transmission element or a contour is added. By properly positioning the pivot on the blade, the lever arm of the spring force, and thus the closing torque before the opening of the door, can be significantly reduced.

When the household appliance is closed, the closing torque is very high, as known in the art. The elements of the inventive household appliance cooperate such that the pivot of the contour is so located that the resulting spring force of a roller of the spring passes the pivot of the contour on the left, so that the contour would turn counter-clockwise if the rivet of the connecting bar in the elongated hole did not prevent this rotation. Due to the small lever arm of the resulting spring force to the pivot of the contour, the torque that attempts to turn the contour counter-clockwise is not very strong, so that the rivet cannot slide to the left due to this supporting force.

However, if the connecting bar is then moved to the left by the motor, the rivet is first moved to the left in the elongated hole. The rivet enables the described rotation of the contour. Because of the rotation of the contour, the lever arm of the resulting spring force to the pivot of the blade is significantly reduced, so that the closing torque is significantly reduced.

During the closing movement of the closure element, the rivet is moved to the right in the elongated hole, so that the contour is rotated back to its starting position. Since the roller of the spring is not in contact with the contour at this point in time when the closure element is open, the motor needs to exert less force at this point in time. Then, the closing process takes place as usual by the connecting piece pulling on the rivet until the closure element (door) is completely closed and the closing torque is high again.

In accordance with an aspect of the invention, the elongated pivot element receptacle of the closure element has an extension along the longitudinal axis. Preferably, the elongated pivot element receptacle is oriented along the longitudinal axis. Alternatively, the elongated pivot element receptacle may also be oriented obliquely at an angle of up to 60 degrees, preferably at an angle of 45 degrees, toward the pivot.

the elongated pivot element receptacle of the closure element oriented along the longitudinal axis when the closure element is in the position closing the access opening. This may be one option for practical implementation.

In accordance with another aspect of the invention, the spring element is oriented along the longitudinal axis. This may be one option for practical implementation.

In accordance with another aspect of the invention, the spring element has a roller via which the spring element is in touching contact with the transmission element. This may be one option for practical implementation.

In accordance with a further aspect of the invention, the closure element has a frame which is pivotally connected by means of the pivot to a housing, preferably a hinge body, the transmission element being pivotally connected to the frame by means of a pivot. This may be one option for practical implementation.

In accordance with another aspect of the invention, the pivot of the frame and the pivot of the transmission element are located at the same height along the vertical axis when the closure element is in the position closing the access opening. This may be one option for practical implementation. Alternatively, the pivot of the transmission element may be located along the vertical axis above the pivot of the frame, in particular vertically above the elongated pivot element receptacle, when the closure element is in the position closing the access opening. In particular, the pivot of the transmission element is vertically farther away from the elongated pivot element receptacle than from the pivot of the frame.

In accordance with a further aspect of the invention, the elongated pivot element receptacle is located high along the longitudinal axis midway between the pivot of the frame and the pivot of the transmission element when the closure element is in the position closing the access opening. This may be one option for practical implementation.

In accordance with another aspect of the invention, the kinematic linkage has a drive lever configured and disposed to be rotationally moved by the drive unit, and the kinematic linkage has a coupling element configured and disposed to translate the rotational movement of the drive lever into a substantially translational movement along the longitudinal axis. This may provide an option for practical implementation, comparable to a connecting rod and piston.

In accordance with a further aspect of the invention, the drive unit has a, preferably electric, motor configured to move the kinematic linkage. This may be one option for implementation.

The above figures are viewed in Cartesian coordinates. A longitudinal axis X can also be referred to as depth X or length X. Perpendicular to longitudinal axis X is a transverse axis Y, which can also be referred to as width Y. A vertical axis Z, which can also be referred to as height Z and corresponds to the direction of gravity, is perpendicular to both the longitudinal axis X and the transverse axis Y. Longitudinal axis X and transverse axis Y together define the horizontal X, Y, which can also be referred to as horizontal plane X, Y.

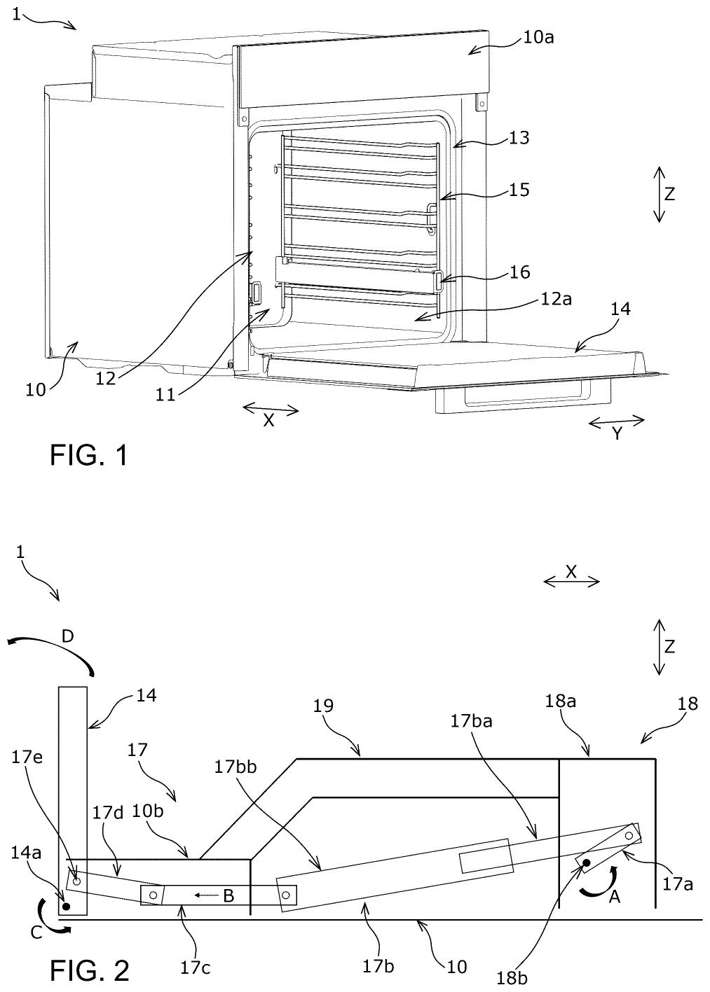

FIG. 1 shows, in a perspective oblique front view from above, an inventive household appliance 1 in the form of a cooking appliance 1 with the access opening 13 open.

A household appliance 1 or cooking appliance 1 according to the invention will be discussed using the example of an oven 1. Oven 1 has an outer enclosure 10, which can also be referred to as outer housing 10 and substantially surrounds or encloses oven 1 outwardly. Outer enclosure 10 represents a carcass, a framework, or a housing of household appliance 1. Outer enclosure 10 terminates with a front panel 10a toward the front, i.e., along longitudinal axis X toward the user.

Disposed within outer enclosure 10 is an inner enclosure 11, which can also be referred to as inner housing 11. Inner enclosure 11 terminates with outer enclosure 10 rearwardly along longitudinal axis X, downwardly and upwardly along vertical axis Z, and along transverse axis Y at both sides, so that an interstitial space is formed between outer enclosure 10 and in inner enclosure 11, which can also be referred to as housing space. This interstitial space represents the interior of oven 1.

Furthermore, inner enclosure 11 substantially encloses an interior space 12, in which a cooking process can be carried out. For this purpose, suitable elements for heating interior space 12 are disposed in the intermediate space or in cooking chamber 12. Accordingly, interior space 12 can also be referred to as cooking chamber 12.

Cooking chamber 12 is accessible to the user along longitudinal axis X from the front through an access opening 13, which is located below front panel 10a. Access opening 13 can be closed and opened by means of a closure element 14 in the form of a drop-down door 14. For this purpose, drop-down door 14 is connected to outer enclosure 10 of oven 1 by means of at least one hinge such that it is pivotable upward about transverse axis Y, allowing the user to pivot drop-down door 14 upward away from himself/herself in order to close access opening 13 and to pivot it downward toward himself/herself in order to clear access opening 13 and gain access to cooking chamber 12, see FIG. 1.

Cooking chamber 12 has a side wall 12a on both sides along transverse axis Y, each side wall 12a having a removable side rack 15 disposed thereon. Each side rack 15 has a telescopic rail 16 removably attached thereto. The telescopic rails 16 are located at the same height along vertical axis Z and together form a pair of telescopic rails 16. Telescopic rails 16 are each formed of three parts along longitudinal axis X, so that a front rail element is connected via a middle rail element to a rear rail element of a respective telescopic rail 16, the rear rail element being stationarily and removably held on the respective side rack 15.

A cookware item, such as a baking sheet, can be placed by the user on the pair of telescopic rails 16 or the front rail elements thereof in order to be moved into and pulled out of cooking chamber 12 along longitudinal axis X. This can make it easier for the user to insert the baking sheet into cooking chamber 12 and to remove it from cooking chamber 12.

FIG. 2 shows a side view, partly in longitudinal section, of a kinematic linkage 17 of the cooking appliance 1 according to the invention.

Kinematic linkage 17 is disposed laterally in the interstitial space of oven 1 in order to be used by the user to operate drop-down door 14 as a closure element 14 in a motor-driven manner in order not to have to do this himself/herself. The motor-driven movement, in particular for opening the closed drop-down door 14 and subsequently re-closing the opened drop-down door 14 (see FIG. 1), can be caused by the user in particular by operating a corresponding control element, which may be disposed on the outside of drop-down door 14 and or on front panel 10a.

To accomplish these movements, oven 1 has a drive unit 18 in the interstitial space. A motor holder 18a of drive unit 18 has an electric motor, whose stator is stationarily fixed to motor holder 18a. Via its rotor, the electric motor can transmit its rotational motion A via a motor pivot 18b to a drive lever 17a of kinematic linkage 17 in one or the other rotational sense, depending on the energization thereof.

Similarly to a connecting rod and piston, drive lever 17a acts as a crank drive and transmits rotational motion A to a coupling element 17b of kinematic linkage 17 as a coupling bar 17b, resulting in a translational displacement or push movement B of a spring holder 17c of kinematic linkage 17. Coupling element 17 or coupling bar 17 includes a first part 17ba as an inner part 17ba and a second part 17bb as an outer part 17bb, which are translationally movable relative to each other by a rotational assembly movement by means of an external thread (not labeled) of inner part 17ba and an internal thread (not labeled) of outer part 17bb. That is, first part 17ba and second part 17bb can produce a change in length, allowing coupling bar 17b to be adjusted to and fixed at the desired length to accommodate assembly and manufacturing tolerances of kinematic linkage 17.

At the opposite ends, inner part 17ba is pivotally connected to drive lever 17a, and outer part 17bb is pivotally connected to spring holder 17c. Spring holder 17c is supported against a guide element of outer enclosure 10 by means of a spring in the form of a spiral spring, whereby a closing force or a closing torque is produced which sealingly closes drop-down door 14 in the raised closed state of access opening 13. To ensure this, household appliance 1 has a closing mechanism, which is configured to exert a closing torque on closure element 14 when the raised closure element 14 closes access opening 13. The closing mechanism is in the form of a suitably dimensioned and arranged mechanical spring system.

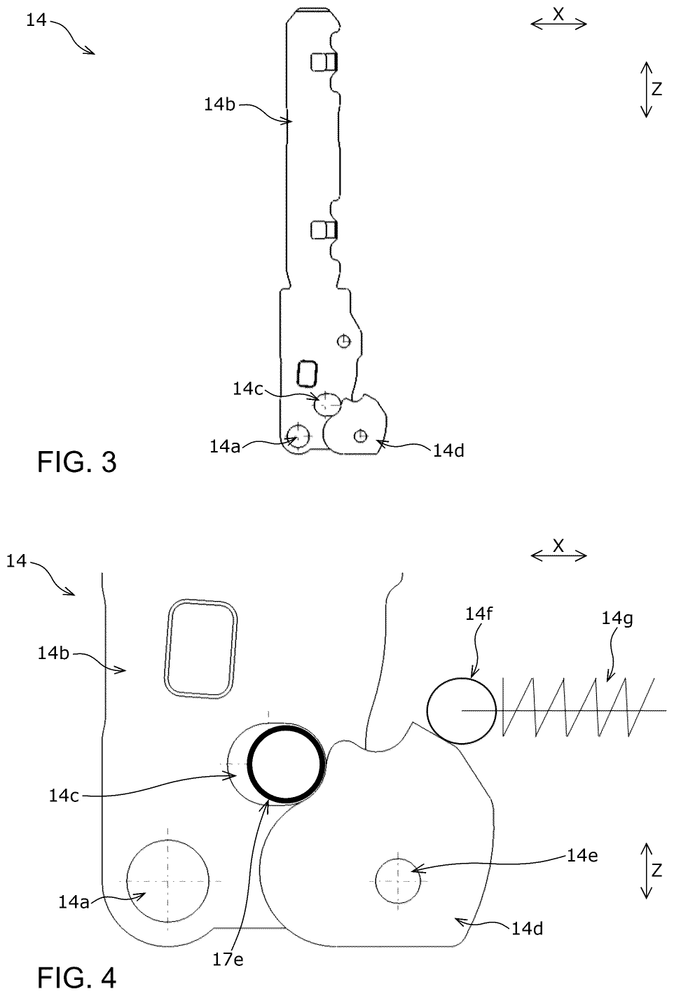

Spring holder 17c transfers push movement B via a connecting element 17d in the form of a connecting bar 17d or connecting piece 17d of kinematic linkage 17 to a frame 14b or a blade 14b (see FIGS. 3 through 6) of drop-down door 14, thereby producing a pivoting movement C about a pivot 14a of drop-down door 14, which results in an opening or closing movement D of drop-down door 14. For this purpose, the end of connecting piece 17d remote from spring holder 17c is pivotally connected to frame 14b by a pivot element 17e in the form of a rivet 17e and is here pivotally held in a pivot element receptacle 14c of closure element 14 (see FIGS. 4 and 6). Drop-down door 14 is mounted by a hinge to a hinge body 10b such that it is pivotable about pivot 14a. Hinge body 10b is is stationarily fixed to a carcass or to a framework, which is represented in FIG. 2 by outer enclosure 10.

If one considers not only the movement of kinematic linkage 17 (including drop-down door 14) alone, but also the forces occurring as a result of it, it is apparent that the resulting reaction forces can be so high that the adjoining components of outer enclosure 10, such as the bottom shell, rear mounting wall, and the like, may be subject to plastic deformation. For this reason, the forces are absorbed where the rigidity of outer enclosure 10 is as high as possible. This is the case in the front region at pivot 14a of drop-down door 14. Therefore, a brace element 19 is provided, which can also be referred to as brace plate 19 or as brace angle 19. Brace angle 19 transmits the torque of the motor via hinge body 10b to outer enclosure 10a, i.e. into the bottom shell, the front frame, and the side walls.

In this connection it should be noted that the resulting forces do not have a constant direction since drive lever 17a acts as a crank drive. The direction of the force changes with the angle of the door's position during the course of movement, so that forces must be absorbed in at least two spatial directions. Brace angle 19 is fixedly connected to hinge body 10b. In order to ensure that brace angle 19 has sufficient stiffness, it may be formed with bends, corners, or indentations.

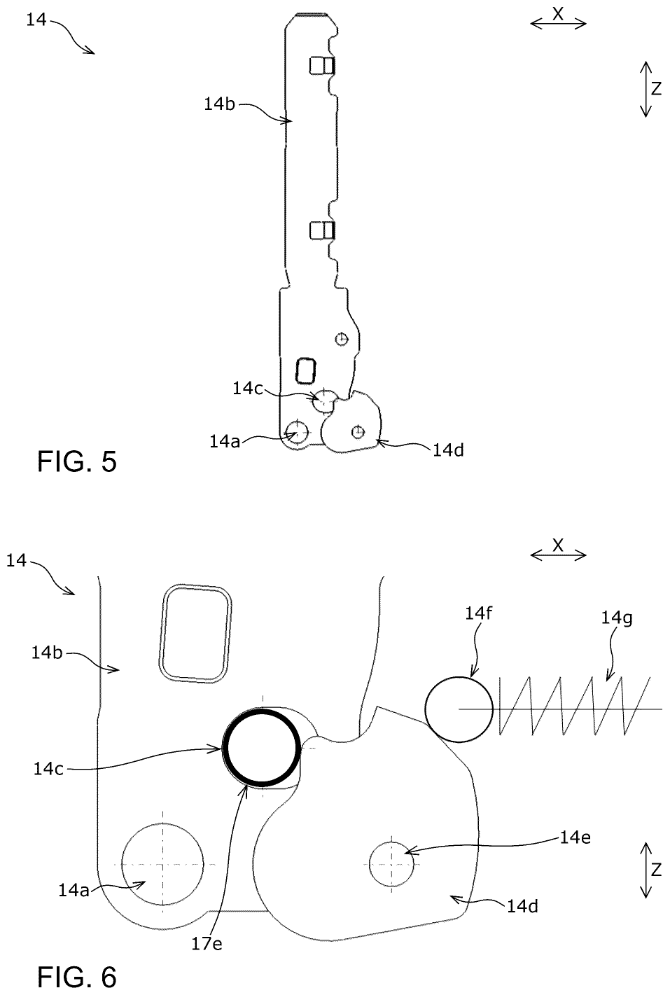

FIG. 3 depicts a side view showing the frame 14b or blade 14b of the closure element 14 of household appliance 1 in a position closing the access opening. FIG. 4 shows a detail view of the lower portion of the closure element of FIG. 3. FIG. 5 depicts a side view showing the frame 14b or blade 14b of the closure element 14 of household appliance 1 at the beginning of an opening movement out of the position closing the access opening. FIG. 6 shows a detail view of the lower portion of the frame 14b of FIG. 5;

FIG. 6 depicts a side view showing the frame 14b or blade 14b of the closure element 14 of household appliance 1 in a position closing the access opening. This illustration shows a design variant of closure element 14 of household appliance 1, which has a different transmission element 14d and a different relative arrangement of pivot 14a and pivot 14e, as well as a different orientation of an elongated pivot element receptacle 14c.

Thus, in accordance with the invention, frame 14b of closure element 14 is provided with an elongated pivot element receptacle 14c, which receives the previously mentioned rivet 17e as a pivot element 17e of kinematic linkage 17 rotationally and translationally movably therein, the translational movement being made possible by the elongated pivot element receptacle 14c of the frame 14b of closure element 14 being configured as an elongated hole. When closure element 14 is in the position closing access opening 13, elongated pivot element receptacle 14c of closure element 14 is oriented along longitudinal axis X or inclined at an angle of up to 45 degrees, in which condition, in particular, the flank of elongated pivot element receptacle 14c that has a smaller distance from the geometric center of cooking chamber 12 is located at a lower position along vertical axis Z.

Closure element 14 also has a transmission element 14d pivotally mounted on closure element 14 or its frame 14b. As mentioned earlier, closure element 14, or more precisely its frame 14b, is pivotally connected to a housing in the form of hinge body 10b by means of pivot 14a. Furthermore, transmission element 14d is in turn pivotally connected to frame 14b by means of a pivot 14c.

According to the embodiments shown in FIGS. 3 through 6, pivot 14a of frame 14b and pivot 14e of transmission element 14d are located at the same height along vertical axis Z when closure element 14 is in the position closing access opening 13.

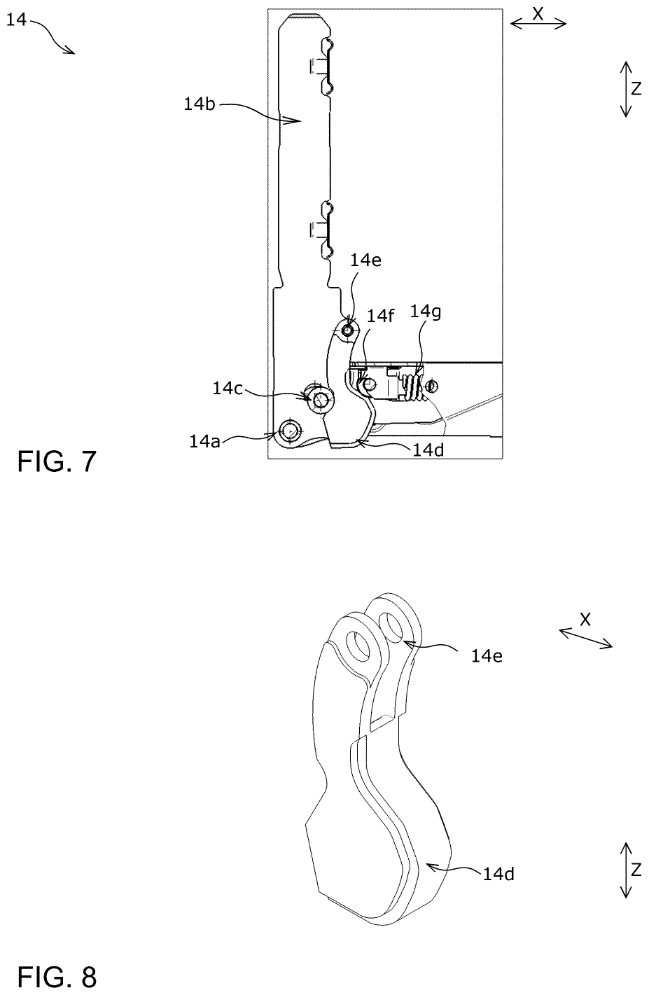

According to the embodiments shown in FIGS. 7 and 8, pivot 14a of frame 14b and pivot 14c of transmission element 14d are located at different heights along vertical axis Z when closure element 14 is in the position closing access opening 13, with pivot 14e of transmission element 14d preferably being located above pivot 14a of frame 14b.

It has proven to be particularly advantageous that pivot 14e of transmission element 14d is located above elongated pivot element receptacle 14c, and pivot 14a of frame 14b is located below elongated pivot element receptacle 14c. In particular, along vertical axis Z, the distance of pivot 14a of frame 14b from elongated pivot element receptacle 14c is smaller than the distance of the pivot 14e of transmission element 14d from elongated pivot element receptacle 14c.

Another aspect, which may be implemented in both design variants, is that elongated pivot element receptacle 14c is located along longitudinal axis X midway between the pivot 14a of frame 14b and pivot 14e of transmission element 14d when closure element 14 is in the position closing access opening 13. A midway position is understood here to mean that the deviation from the mathematical center can, on either side, be up to 20 percent of the distance between pivot 14a of frame 14b and pivot 14e of transmission element 14d along longitudinal axis X.

There is further provided a spring element 14g that is configured to push transmission element 14d of closure element 14 away from access opening 13 against pivot element 17e of kinematic linkage 17 and thereby translationally move pivot element 17e of kinematic linkage 17. Spring element 14g is oriented along longitudinal axis X. Spring element 14g has a roller 14f via which spring element 14g is in touching contact with transmission element 14d.

In accordance with the invention, pivot 14a, pivot element receptacle 14c, transmission element 14d, and spring element 14g are configured such that pivot element 17e of kinematic linkage 17 moves along elongated pivot element receptacle 14c of closure element 14 toward transmission element 14d and pivots transmission element 14d against spring element 14g, thereby creating a greater lever arm between spring element 14g and pivot 14a of closure element 14 when pivot element 17e of kinematic linkage 17 is moved by drive unit 18 to the position closing access opening 13.

Furthermore, pivot 14a, pivot element receptacle 14c, transmission element 14d, and spring element 14g are configured such that pivot element 17e of kinematic linkage 17 moves along elongated pivot element receptacle 14c of closure element 14 away from transmission element 14d, and spring element 14g pivots transmission element 14d, thereby creating a smaller lever arm between spring element 14g and pivot 14a of closure element 14 when pivot element 17e of kinematic linkage 17 is moved by drive unit 18 out of the position closing access opening 13.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Characters (Part of the Description)

A rotational motion of the motor
B push movement of spring holder 17c
C pivoting movement about pivot 14a of closure element 14
D opening or closing movement of closure element 14
X longitudinal axis; depth; length
Y transverse axis; width
Z vertical axis; height
X, Y horizontal; horizontal plane
1 household appliance; cooking appliance; oven
10 outer enclosure; outer housing
10a front panel
10b hinge body
11 inner enclosure; inner housing
12 interior space; cooking chamber
12a side walls of cooking chamber 12
13 access opening
14 closure element; drop-down door
14a pivot of closure element 14
14b frame or blade of closure element 14
14c elongated pivot element receptacle or elongated hole of closure element 14
14d transmission element of closure element 14
14e pivot of the transmission element of closure element 14
14f roller of closure element 14
14g spring element of closure element 14
15 side rack
16 telescopic rails
17 kinematic linkage
17a drive lever
17b coupling element; coupling bar
17ba first part or inner part of coupling element 17
17bb second part or outer part of coupling element 17
17c spring holder
17d connecting element; connecting bar
17e pivot element; rivet
18 drive unit
18a motor holder
18b motor pivot
19 brace element; brace plate; brace angle

1. A household appliance, comprising:
an interior space configured to receive at least one object to be treated through an access opening along a longitudinal axis;
a closure element configured for closing and clearing the access opening to the interior space from a front of the household appliance by being pivoted up and down about a pivot;
a closing mechanism configured to exert a closing torque on the closure element when the closure element is in a pivoted-up position and closes the access opening;
a kinematic linkage configured to transmit a driving force of a drive unit to the closure element and thereby pivot the closure element up and down, and to overcome the closing torque of the closing mechanism while the closure element is being pivoted down;
an elongated pivot element receptacle of the closure element, the elongated pivot element receptacle being configured to receive a pivot element of the kinematic linkage rotationally and translationally movably therein;
a transmission element pivotally mounted on the closure element; and
a spring element configured to push the transmission element of the closure element away from the access opening against the pivot element of the kinematic linkage and thereby translationally move the pivot element of the kinematic linkage.

2. The household appliance of claim 1, wherein the pivot, the pivot element receptacle, the transmission element, and the spring element are configured such that:
the pivot element of the kinematic linkage moves along the elongated pivot element receptacle of the closure element toward the transmission element and pivots the transmission element against the spring element, thereby creating a greater lever arm between the spring element and the pivot of the closure element when the pivot element of the kinematic linkage is moved by the drive unit to a position closing the access opening, and
the pivot element of the kinematic linkage moves along the elongated pivot element receptacle of the closure element away from the transmission element, and the spring element pivots the transmission element, thereby creating a smaller lever arm between the spring element and the pivot of the closure element when the pivot element of the kinematic linkage is moved by the drive unit out of a position closing the access opening.

3. The household appliance of claim 1, wherein the elongated pivot element receptacle of the closure element has an extension along the longitudinal axis.

4. The household appliance of claim 3, wherein the spring element is oriented along the longitudinal axis.

5. The household appliance of claim 1, wherein the spring element has a roller via which the spring element is in touching contact with the transmission element.

6. The household appliance of claim 1, wherein the closure element has a frame which is pivotally connected by the pivot to a housing,
wherein the transmission element is pivotally connected to the frame by a pivot.

7. The household appliance of claim 6, wherein the pivot of the frame and the pivot of the transmission element are located at a same height along a vertical axis when the closure element is in a position closing the access opening, or
wherein the pivot of the transmission element is located along a vertical axis above the pivot of the frame so as to be vertically closer to the elongated pivot element receptacle than to the pivot of the frame when the closure element is in a position closing the access opening.

8. The household appliance of claim 6, wherein the elongated pivot element receptacle is located along the longitudinal axis midway between the pivot of the frame and the pivot of the transmission element when the closure element is in a position closing the access opening.

9. The household appliance of claim 1, wherein the kinematic linkage comprises a drive lever configured and disposed to be rotationally moved by the drive unit, and
wherein the kinematic linkage has a coupling element configured and disposed to translate a rotational movement of the drive lever into a substantially translational movement along a longitudinal axis.

10. The household appliance of claim 1 wherein the drive unit comprises a motor configured to move the kinematic linkage.

11. The household appliance of claim 1, wherein the household appliance comprises a cooking appliance.

12. The household appliance of claim 3, wherein the elongated pivot element receptacle is oriented along the longitudinal axis or oriented obliquely at an angle of up to 60 degrees toward the pivot when the closure element is in the position closing the access opening.

13. The household appliance of claim 12, wherein the angle is up to 45 degrees.

14. The household appliance of claim 6, wherein the frame is pivotally connected by the pivot to a hinge body.

15. The household appliance of claim 10, wherein the motor comprises an electric motor.
